(19) United States
(12) Patent Application Publication
(10) Pub. No.: US 2026/0280176 A1
(43) Pub. Date: Sep. 17, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Akiko SUZUKI, Mie (JP); Hajime MATSUI, Mie (JP); Shuhei YAMADA, Mie (JP)

(21) Appl. No.: 19/168,811

(22) PCT Filed: Mar. 21, 2024
(86) PCT No.: PCT/JP2024/011012

§ 371 Date: Sep. 25, 2025

(30) Foreign Application Priority Data
Apr. 3, 2023 (JP) 2023-059913

(51) Int. Cl. H01R 13/424

(52) U.S. Cl. CPC H01R 13/424

(57) ABSTRACT

A connector for holding a terminal via a terminal holder includes a terminal-equipped wire including a wire and a terminal mounted on an end part of the wire, a terminal holder including a cavity for holding the terminal, and a housing including a holder holding portion for holding the terminal holder and a wire guiding portion for guiding the wire extending out from the holder holding portion. The terminal holder includes a protrusion projecting outward on an outer peripheral part of a rear end part of the terminal holder where the wire extends out. The holder holding portion includes a holder accommodation space for accommodating the terminal holder and a recess, into which the protrusion is at least partially fit.

### TECHNICAL FIELD

The present disclosure relates to a connector.

### BACKGROUND

Patent Document 1 discloses a connector provided with a terminal fitting, a sub-housing for accommodating the terminal fitting in a retained state, and a housing for accommodating the terminal fitting and the sub-housing in a retained state.

### PRIOR ART DOCUMENT

### Patent Document

Patent Document 1: JP 2017-126408 A

### SUMMARY OF THE INVENTION

### Problems to be Solved

In a configuration for holding a terminal holder in a housing, it is desired to improve the strength of a rear end part of the terminal holder where a wire extends out and enable this rear end part to be firmly held in the housing.

Accordingly, the present disclosure aims to improve the strength of a rear end part of a terminal holder where a wire extends out and enable this rear end part to be firmly held in a housing in a configuration for holding the terminal holder in the housing.

### Means to Solve the Problem

The present disclosure is directed to a connector for holding a terminal via a terminal holder, the connector being provided with a terminal-equipped wire including a wire and the terminal mounted on an end part of the wire, the terminal holder including a cavity for holding the terminal, and a housing including a holder holding portion for holding the terminal holder and a wire guiding portion for guiding the wire extending out from the holder holding portion, the terminal holder including a protrusion projecting outward on an outer peripheral part of a rear end part of the terminal holder where the wire extends out, and the holder holding portion including a holder accommodation space for accommodating the terminal holder and a recess, the protrusion being at least partially fit into the recess.

### Effect of the Invention

According to the present disclosure, the strength of a rear end part of a terminal holder where a wire extends out can be improved and this rear end part can be firmly held in a housing in a configuration for holding the terminal holder in the housing.

### BRIEF DESCRIPTION OF THE DRAWINGS

FIG. 1 is a perspective view showing a connector according to an embodiment.

FIG. 2 is a perspective view showing the connector.

FIG. 3 is an exploded perspective view showing the connector.

FIG. 4 is an exploded perspective view showing the connector.

FIG. 5 is a section along V-V of FIG. 1.

FIG. 6 is an exploded perspective view showing a terminal module.

FIG. 7 is a perspective view partly in section of a housing.

FIG. 8 is a perspective view partly in section of the housing.

FIG. 9 is a perspective view partly in section of the housing.

FIG. 10 is a section along X-X of FIG. 2.

FIG. 11 is a diagram showing a state where a protrusion of a terminal holder is fit in a recess.

FIG. 12 is a back view showing the terminal module held in a holder holding portion.

FIG. 13 is perspective view showing another connector.

FIG. 14 is an exploded perspective view showing the connector.

FIG. 15 is a perspective view partly in section of a housing.

FIG. 16 is a section along XVI-XVI of FIG. 13.

FIG. 17 is a back view showing a terminal module held in a holder holding portion.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is for holding a terminal via a terminal holder, and provided with a terminal-equipped wire including a wire and the terminal mounted on an end part of the wire, the terminal holder including a cavity for holding the terminal, and a housing including a holder holding portion for holding the terminal holder and a wire guiding portion for guiding the wire extending out from the holder holding portion, the terminal holder including a protrusion projecting outward on an outer peripheral part of a rear end part of the terminal holder where the wire extends out, and the holder holding portion including a holder accommodation space for accommodating the terminal holder and a recess, the protrusion being at least partially fit into the recess.

According to the present disclosure, since the terminal holder includes the protrusion projecting outward on the outer peripheral part of the rear end part where the wire extends out, the strength of the rear end part of the terminal holder where the wire extends out is improved. Further, since the protrusion is fit into the recess of the housing, the rear end part of the terminal holder can be firmly held in the housing.

(2) In the connector of (1), the protrusion may have a support target surface facing in a guiding direction of the wire by the wire guiding portion, and the recess may have a support surface facing the support target surface.

If the wire is pulled in the guiding direction of the wire, the rear end part of the terminal holder is also pulled in the guiding direction. According to this connector, the support target surface contacts the support surface, thereby restricting a movement of the rear end part of the terminal holder in the guiding direction. Thus, the rear end part of the terminal holder can be firmly held in the housing.

(3) In the connector of (1) or (2), the protrusion may include an edge reinforcing portion along an edge of the rear end part of the terminal holder.

In this way, a part, to which a force is easily applied when the wire is pulled, is reinforced by the edge reinforcing portion.

(4) In the connector of (3), the edge reinforcing portion may include a first supporting end part, a second supporting end part and a coupling portion coupling the first and second supporting end parts, the first and second supporting end parts may be supported in the recess when the wire is pulled in the guiding direction of the wire by the wire guiding portion, and the coupling portion may include an arched part concave toward a side opposite to the guiding direction of the wire.

In this way, when the wire is pulled, the coupling portion between the first and second supporting end parts can be firmly supported by an arch structure. In this way, even if a part between the first and second supporting end parts, out of the terminal holder, cannot be directly supported by the housing, this part between the first and second supporting end parts can be firmly supported.

(5) In the connector of any one of (1) to (4), the protrusion may include a rib portion extending along an extension direction of the cavity.

In this case, the terminal holder is hardly deformed to be bent with respect to an extension direction of the terminal.

(6) In the connector of any one of (1) to (5), the terminal holder may include a base holder, an intermediate holder to be overlapped on the base holder and a cover holder to be overlapped on the intermediate holder on a side opposite to the base holder, each of the base holder and the intermediate holder may be formed with the cavity, and the intermediate holder may be formed with the protrusion.

Since the intermediate holder is arranged between the base holder and the cover holder, it is difficult to bring the intermediate holder into contact with a surface surrounding the holder accommodation space. Accordingly, by forming the intermediate holder with the protrusion and fitting the protrusion into the recess, the intermediate holder is easily positioned.

(7) In the connector of (6), the wire guiding portion may guide the wires along an overlapping direction of the base holder, the intermediate holder and the cover holder, the protrusion may include an intersecting protrusion projecting in a direction intersecting the overlapping direction, and the intersecting protrusion may be fit into the recess to be able to contact an inner surface of the recess in a guiding direction of the wire.

In this case, the intermediate holder arranged between the base holder and the cover holder can be effectively restricted in position in the guiding direction of the wire by the intersecting protrusion projecting in the direction intersecting the overlapping direction.

(8) In the connector of (6), the wire guiding portion may guide the wires along a direction intersecting both an extension direction of the cavities and an overlapping direction of the base holder, the intermediate holder and the cover holder, the protrusion may include a guiding direction-side protrusion projecting in the guiding direction of the wires, and a top part of the guiding direction-side protrusion may be fit into the recess to be able to contact an inner surface of the recess.

In this case, the intermediate holder can be effectively restricted in position in the guiding direction of the wire by bringing the top part of the guiding direction-side protrusion into contact with the inner surface of the recess.

(9) In the connector of any one of (6) to (8), the intermediate holder may extend more outward than the base holder in an extension direction of the cavities.

In this case, the rear end part of the intermediate holder is easily reinforced and firmly held at a fixed position by the protrusion formed on the intermediate holder.

(10) In the connector of (9), the protrusion may include a rib portion extending along the extension direction of the cavities, and the rib portion may extend in the extension direction of the cavities toward the rear end part from a position opposite to a rear end surface of the base holder in an extension direction of the wires.

In this case, a part extending from the base holder, out of the intermediate holder, can be firmly reinforced by the rib portion. Further, if the rib portion is held in the recess, the part extending from the base holder, out of the intermediate holder, can be firmly held by the rib portion.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a connector according to an embodiment is described.

### <Overall Structure>

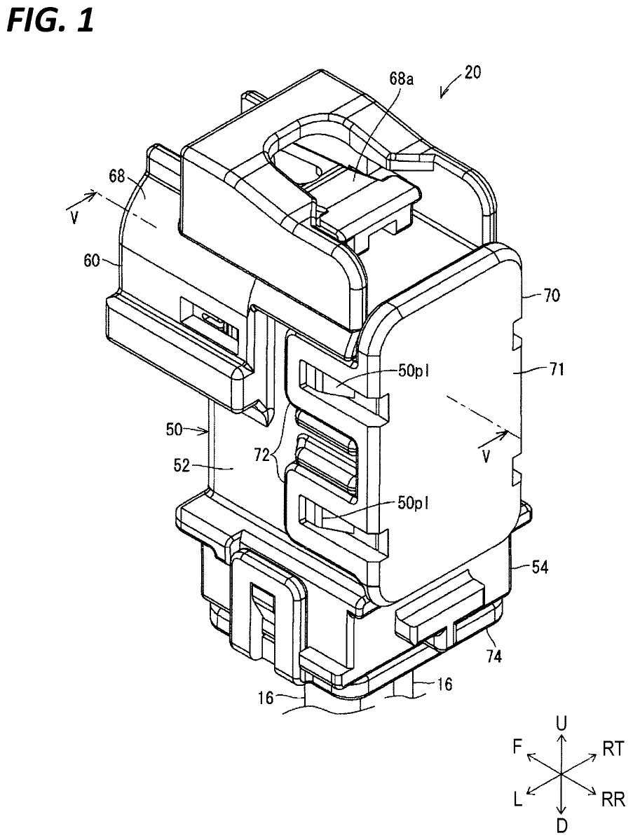

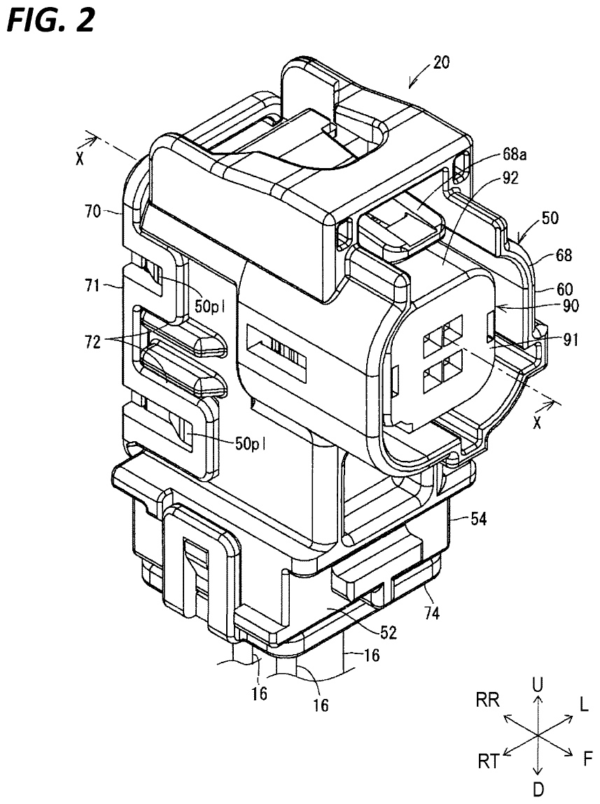

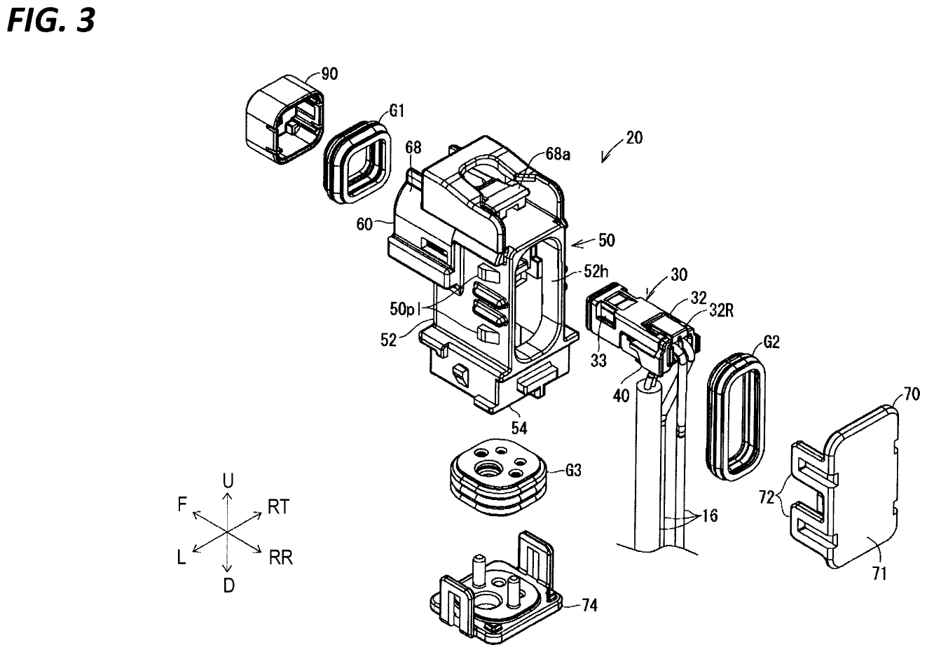

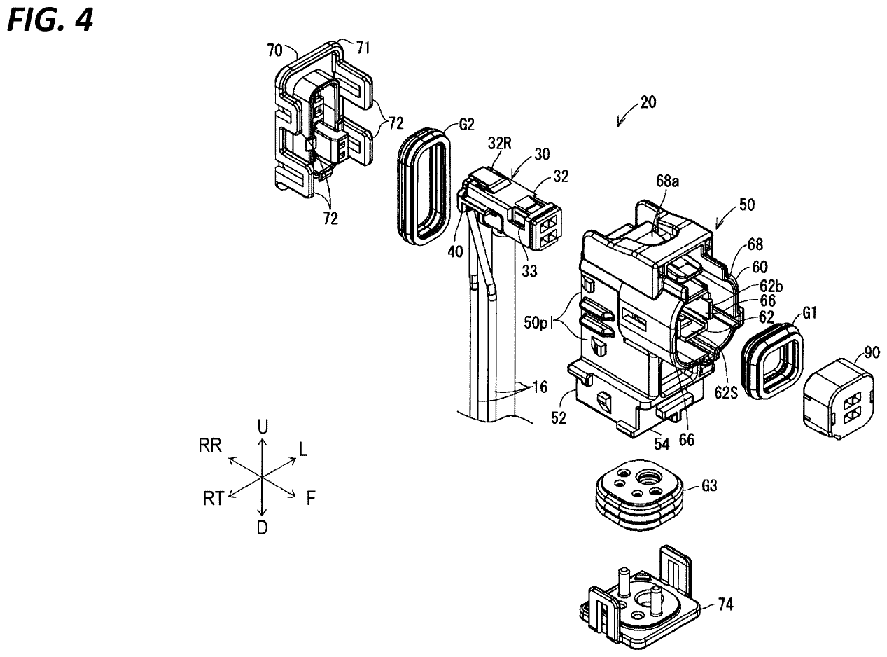

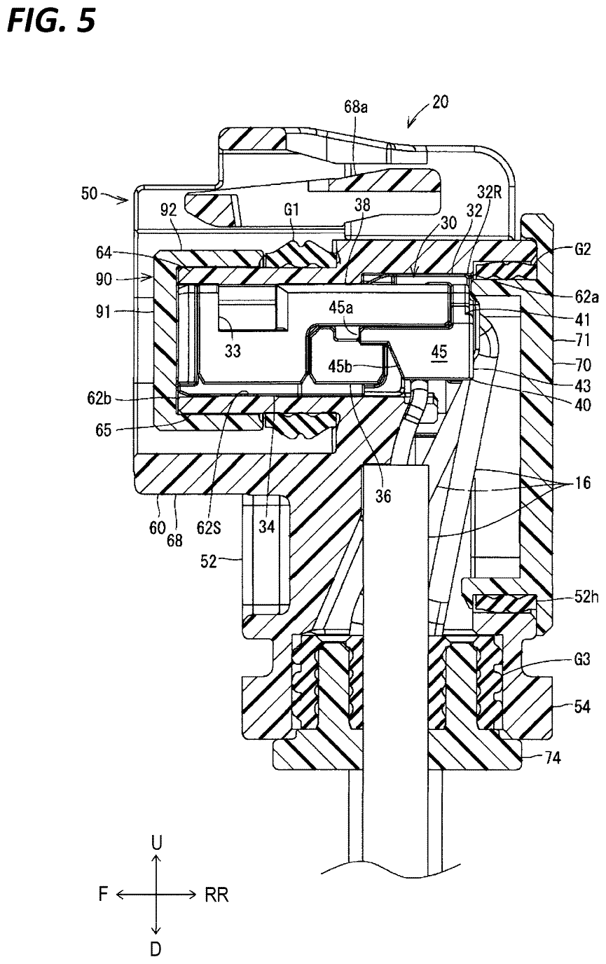

An overall structure of the connector is described. FIGS. 1 and 2 are perspective views showing a connector 20. FIGS. 3 and 4 are exploded perspective views showing the connector 20. FIG. 5 is a section along V-V of FIG. 1.

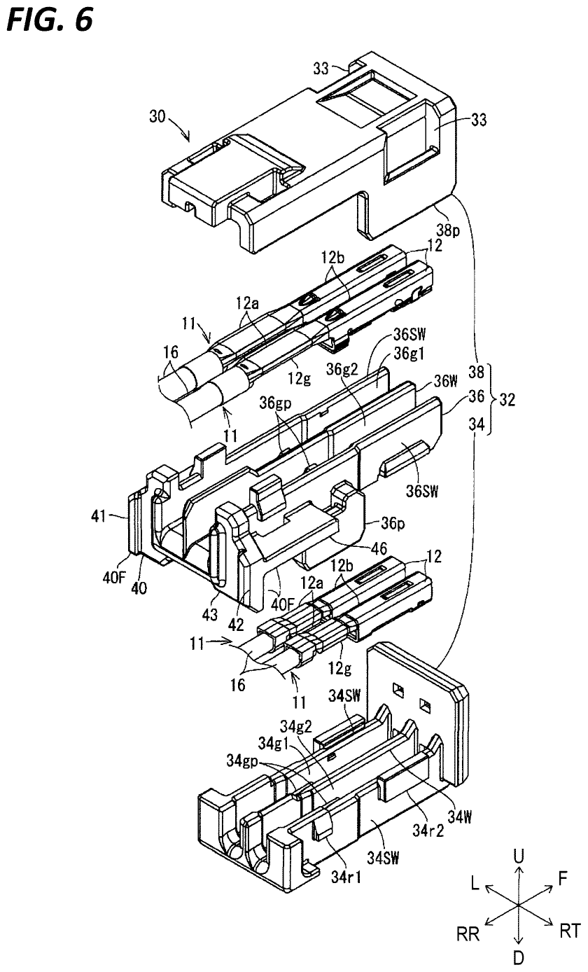

The connector 20 is a connector for holding terminals 12 via a terminal holder 32. The terminals 12 and the terminal holder 32 are described later with reference to FIG. 6 and the like. By connecting a mating connector to this connector 20, mating terminals of the mating connector are connected to the terminals 12.

The connector 20 is provided with terminal-equipped wires 11, the terminal holder 32 and a housing 50.

The terminal-equipped wire 11 includes a wire 16 and the terminal 12 mounted on an end part of the wire 16.

The terminals 12 are accommodated in the terminal holder 32. A terminal module 30 is constituted by the terminals 12 and the terminal holder 32 for accommodating the terminals 12. The wires 16 extend outward from the terminal holder 32. The terminals 12 are mounted into the housing 50 while being mounted in the terminal module 30.

The housing 50 holds the terminals 12 via the terminal holder 32. The housing 50 includes a holder holding portion 60 and a wire guiding portion 52. The terminal holder 32 is accommodated into the holder holding portion 60. The wire guiding portion 52 is integrally connected to the holder holding portion 60 and guides the wires 16 extending out from the holder holding portion 60. An extension direction of the wires 16 from the connector 20 is guided by the wire guiding portion 52.

Note that a retainer 90 is mounted into the holder holding portion 60. The terminal module 30 is held not to come out from the housing 50 by the retainer 90. In this embodiment, the retainer 90 is mounted into the housing 50 from a side opposite to a pull-out direction of the wires 16 from the terminal module 30. Such a retainer 90 may be called a front retainer.

The mating connector is connected to this connector 20 from the side opposite to the pull-out direction of the wires 16 from the terminal module 30. In the following description, for the sake of convenience, a side where the mating connector is connected may be referred to as a front side and an opposite side thereof may be referred to as a rear side. Further, a lock piece 68a for maintaining a connected state to the mating connector is located in the housing 50. For the sake of convenience, a side where the lock piece 68a is located with respect to the housing 50 may be referred to as an upper side and an opposite side thereof may be referred to as a lower side. Further, left and right sides may be referred to based on these front, rear, upper and lower sides.

The configuration of each component is described.

### <Concerning Terminal Module>

FIG. 6 is an exploded perspective view showing the terminal module 30. As shown in FIGS. 3 to 6, the terminal module 30 includes the terminals 12 and the terminal holder 32. The terminal 12 is a component formed, such as by press-working a metal plate, and includes a wire connecting portion 12a and a terminal connecting portion 12b. The wire connecting portion 12a and the terminal connecting portion 12b are, for example, linearly connected. The wire connecting portion 12a in one end part of the terminal 12 is connected to the end part of the wire 16 by crimping or the like. The terminal connecting portion 12b is, for example, formed into a tubular shape, and a pin-like or tab-like male connecting portion of the mating terminal is inserted and connected to the terminal connecting portion 12b.

In this embodiment, the terminal module 30 includes a plurality of the terminals 12. More specifically, the terminal module 30 includes four terminals 12. The four terminals 12 are so arranged that two terminals 12 are laterally arranged in each of two stages in a vertical direction. A plurality of the wires 16 extend out from the rear end of the terminal module 30. The number of the terminals 12 to be held by the terminal module 30 is arbitrary and the terminal module 30 may include only one, two or more terminals.

The terminal holder 32 is a resin component including cavities 34g1, 34g2, 36g1 and 36g2 for accommodating the terminals 12. The terminal holder 32 holds the plurality of terminals 12 in a predetermined array while insulating the terminals 12 from each other. The terminal holder 32 is held in the housing 50 with the plurality of terminals 12 held by the terminal holder 32. In this way, the plurality of terminals 12 can be easily held in a predetermined array state in the housing 50.

More specifically, the terminal holder 32 includes a base holder 34, an intermediate holder 36 and a cover holder 38. The intermediate holder 36 is overlapped on the base holder, and the cover holder 38 is overlapped on the intermediate holder 36 on a side opposite to the base holder 34.

The base holder 34 is formed with a plurality of (here, two) cavities 34g1, 34g2. The cavities 34g1, 34g2 are arranged in parallel and open on upper and rear sides. A front wall 34FW stands on the front edge of the base holder 34. The terminals 12 are arranged into the cavities 34g1, 34g2 through upper and rear openings of the cavities 34g1, 34g2. The cavity 34g1 is an example of a first cavity, and the cavity 34g2 is an example of a second cavity. The base holder 34 may be formed with more cavities.

The base holder 34 includes a partition wall 34W and a pair of side walls 34SW. The partition wall 34W is a wall partitioning between the first and second cavities 34g1, 34g2. The pair of side walls 34SW are walls defining both outer sides of the cavities 34g1, 34g2.

A positioning protrusion 34gp projects on a bottom part of the cavity 34g1, 34g2. The terminal 12 includes a recess 12g recessed between a coating crimping portion to be crimped to a coating of the wire, out of the wire connecting portion 12a, and the terminal connecting portion 12b. By fitting the positioning protrusion 34gp into the recess 12g of the terminal 12, the terminal 12 is positioned in the positioning protrusion 34gp.

The intermediate holder 36 is a component spreading to such an extent as to be able to close the upper openings of the plurality of cavities 34g1, 34g2. The intermediate holder 36 includes locking pieces 36p lockable to locking protrusions 34r1 of the base holder 34.

With the upper openings of the plurality of cavities 34g1, 34g2 closed by the intermediate holder 36, the locking pieces 36p are locked to the locking protrusions 34r1 on both sides of the base holder 34, whereby the intermediate holder 36 is held in a state overlapped on the base holder 34. In this state, the terminals 12 in the cavities 34g1, 34g2 are restricted from moving upward, and the state where the positioning protrusions 34gp are fit in the recesses 12g is maintained.

The intermediate holder 36 includes a plurality of (here, two) cavities 36g1, 36g2 located on a side opposite to the base holder 34. The cavities 36g1, 36g2 are arranged in parallel and open on upper and rear sides. With the intermediate holder 36 united with the base holder 34, the front wall 34FW of the base holder 34 is located forward of front openings of the cavities 36g1, 36g2. The terminals 12 are arranged into the cavities 36g1, 36g2 through upper and rear openings of the cavities 36g1, 36g2.

The cavity 36g1 is an example of the first cavity, and the cavity 36g2 is an example of the second cavity. The base holder 34 may be formed with more cavities.

The intermediate holder 36 includes a partition wall 36W and a pair of side walls 36SW. The partition wall 36W is a wall partitioning between the first and second cavities 36g1, 36g2. The pair of side walls 36SW are walls defining both outer sides of the cavities 36g1, 36g2.

A positioning protrusion 36gp projects on a bottom part of the cavity 36g1, 36g2. By fitting the positioning protrusion 36gp into the recess 12g of the terminal 12, the terminal 12 is positioned in the positioning protrusion 36gp.

If the terminal holder 32 is provided with a plurality of the intermediate holders 36, the terminal holder 32 can hold the terminals 12 in three or more stages in the vertical direction.

The intermediate holder 36 extends more outward, i.e. rearward, than the base holder 34 in an extension direction of the cavities 34g1, 34g2, 36g1 and 36g2.

The cover holder 38 is a component spreading to such an extent as to be able to close the upper openings of the plurality of cavities 36g1, 36g2. The cover holder 38 includes locking pieces 38p lockable to locking protrusions 34r2 of the base holder 34.

With the upper openings of the plurality of cavities 36g1, 36g2 closed by the cover holder 38, the locking pieces 38p are locked to the locking protrusions 34r2 on the both sides of the base holder 34 beyond the outside of the intermediate holder 36. In this way, the cover holder 38 is held in a state united with the base holder 34 with the intermediate holder 36 arranged between the base holder 34 and the cover holder 38. In this state, the terminals 12 in the cavities 36g1, 36g2 are restricted from moving upward, and the state where the positioning protrusions 36gp are fit in the recesses 12g is maintained.

With the plurality of terminals 12 held by the terminal holder 32, the plurality of wires 16 extend out from the rear openings of the cavities 34g1, 34g2, 36g1 and 36g2.

Further, the front wall 34FW is formed with through holes, through which the mating terminals can pass. Each of the plurality of mating terminals is connected to the corresponding terminal 12 through the through hole.

Locking recesses 33, to which locking lances 66 are lockable, are formed in the side surfaces of the terminal holder 32. In this embodiment, a rectangular hole penetrating in an in-out direction is formed in a base end part of the locking piece 38p of the cover holder 38, and this hole is the locking recess 33. A recess, to which a locking lance is locked, may be a bottomed recess.

A configuration for reinforcing and firmly holding a rear end part 32R of the terminal holder 32 in the housing 50 is described in more detail later.

### <Concerning Housing>

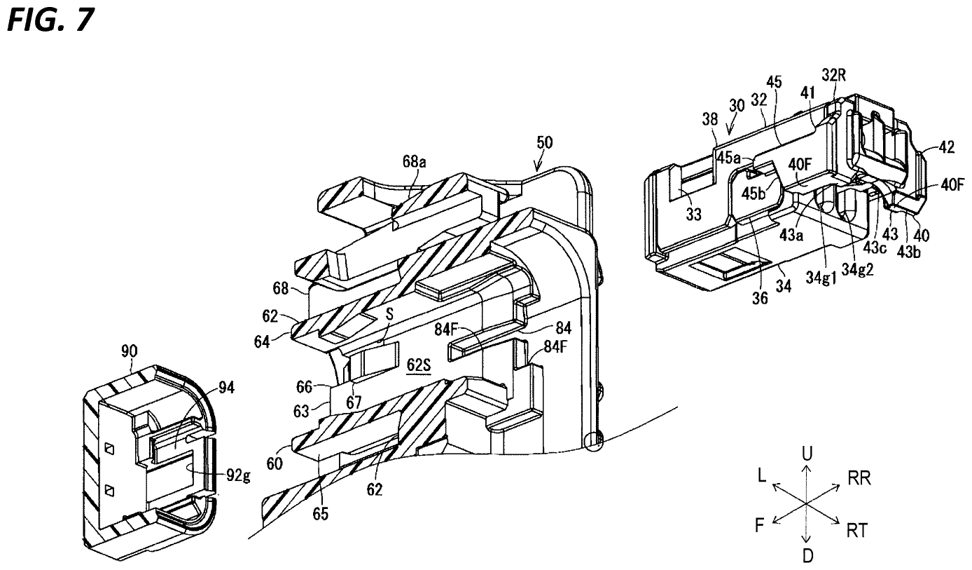

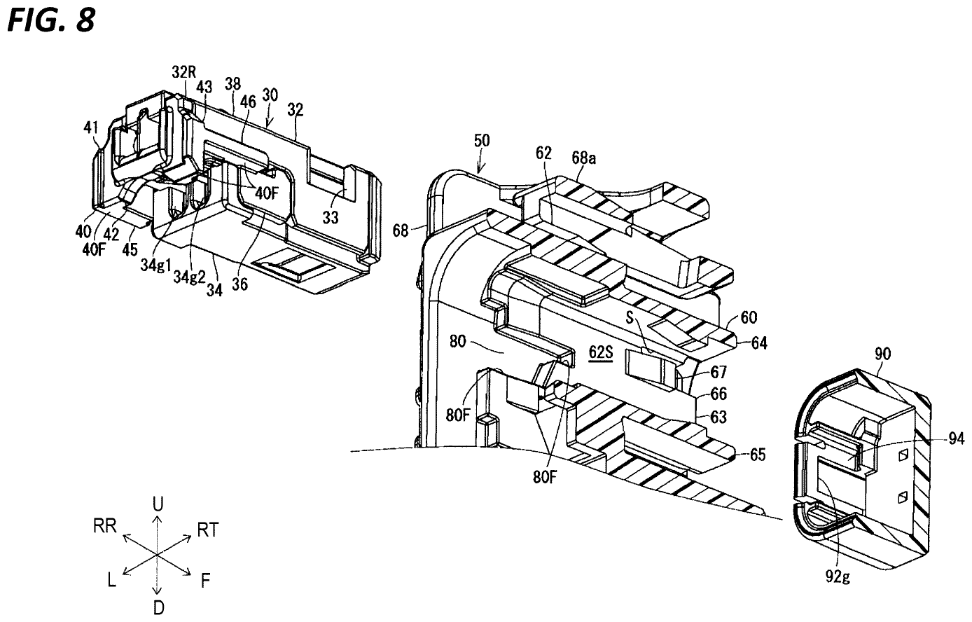

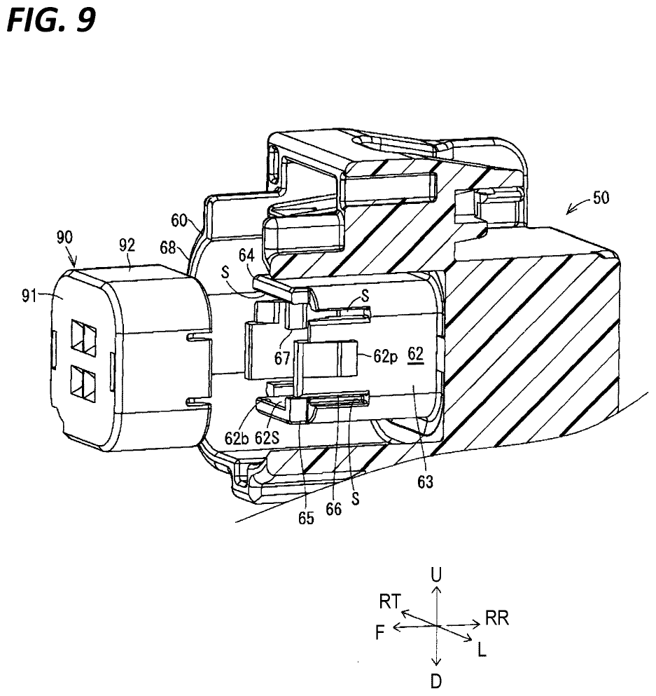

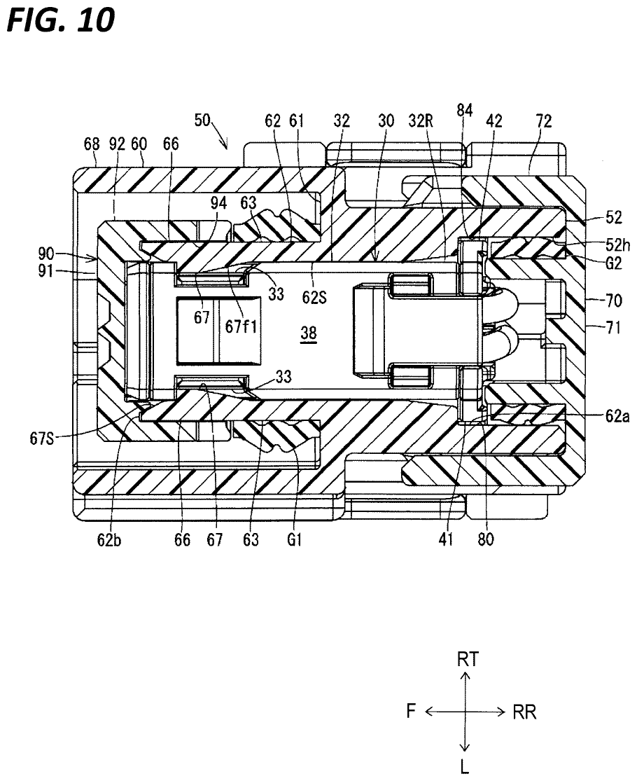

FIGS. 7 and 8 are perspective views partly in section of the housing 50. In FIGS. 7 and 8, the holder holding portion 60 is cut in a lateral intermediate part. FIG. 7 shows the internal structure of the holder holding portion 60 when viewed from left, and FIG. 8 shows the internal structure of the holder holding portion 60 when viewed from right. FIG. 9 is a perspective view partly in section of the housing 50 so that an engaged part of the housing 50 with the retainer 90 is seen. FIG. 10 is a section along X-X of FIG. 2. In FIG. 10, the terminal module 30 is drawn not as a section, but as a plan view.

As shown in FIGS. 1 to 5 and 7 to 10, the housing 50 is a molded component made of resin or the like. As described above, the housing 50 is provided with the holder holding portion 60 and the wire guiding portion 52.

The holder holding portion 60 is a part for holding the terminals 12 by holding the terminal module 30. Further, the holder holding portion 60 is a part to be connected to the mating connector while holding the terminals 12.

In this embodiment, the holder holding portion 60 is provided with an accommodation wall portion 62 and an outer wall portion 68.

The accommodation wall portion 62 is formed into a tubular shape to surround the terminal module 30. The outer wall portion 68 is formed into a tubular shape to surround a front part of the accommodation wall portion 62 while being spaced apart therefrom. In this embodiment, the accommodation wall portion 62 and the outer wall portion 68 are in the form of rectangular tubes. Here, the rectangular tube may be not only a rectangular tube with right-angle corners, but also a rectangular tube with rounded corners.

Out of the accommodation wall portion 62, a rear opening is a first opening 62a and a front opening is a second opening 62b. The terminal module 30 is arranged in the accommodation wall portion 62 with the wires 16 pulled out through the first opening 62a.

An intermediate part in an extension direction of the accommodation wall portion 62 and a rear end part of the outer wall portion 68 are connected via a coupling wall 61. That is, the coupling wall 61 is located in the intermediate part in the extension direction of the accommodation wall portion 62, and a part of the accommodation wall portion 62 forward of the coupling wall 62 forms a double wall together with the outer wall portion 68.

The front part of the accommodation wall portion 62 and the outer wall portion 68 are parts to be connected to the mating connector. A tubular part of the mating connector can enter between the front part of the accommodation wall portion 62 and the outer wall portion 68. Thus, connected parts of the terminals 12 and the mating terminals are surrounded by the accommodation wall portion 62, the tubular part of the mating connector and the outer wall portion 68. In this way, water cut-off performance and protection performance of the terminal connected parts are enhanced. Further, an annular resilient member G1 can be interposed between the accommodation wall portion 62 and the tubular part of the mating connector, whereby the water cut-off performance for the connected parts is enhanced.

The lock piece 68a to be locked to the mating connector is formed in a circumferential part (upper part) of the outer wall portion 68.

A rear part of the accommodation wall portion 62 is formed to be thicker than the front part, and extends further rearward than the rear end of the outer wall portion 68. Recesses 80, 84, into which a protrusion 40 of the terminal holder 32 to be described later is at least partially fit, are formed in inward facing parts of the rear part of the accommodation wall portion 62.

The holder holding portion 60 includes the locking lances 66. The locking lance 66 is formed to be resiliently deformable with a base end connected to the accommodation wall portion 62 as a fulcrum. The locking lance 66 includes a locking protrusion 67 lockable to the terminal module 30 in the accommodation wall portion 62 by projecting inwardly of the accommodation wall portion 62.

The locking lance 66 is formed to be resiliently deformable inward and outward of the accommodation wall portion 62. The locking protrusion 67 of the locking lance 66 projects inwardly of the accommodation wall portion 62 in an initial state. When the terminal module 30 is inserted into the accommodation wall portion 62, the locking lances 66 are resiliently deformed outward to allow the insertion of the terminal module 30. With the terminal module 30 accommodated in the accommodation wall portion 62, the locking lances 66 return to original positions on an inner peripheral side by resilient forces.

In this way, the locking protrusions 67 can be locked to the terminal module 30.

More specifically, the front part of the accommodation wall portion 62 includes a pair of side walls 63, an upper wall 64 and a lower wall 65. The pair of side walls 63, the upper wall 64 and the lower wall 65 are connected to form a rectangular tube.

The upper and lower walls 64, 65 extend further forward than the pair of side walls 63. The plate-like locking lances 66 extend from the front edges of the pair of side walls 63.

The locking lance 66 is formed to be resiliently deformable inward and outward of the accommodation wall portion 62. In this embodiment, the locking lance 66 is in the form of a plate extending forward from the front edge of the side wall 63. Slits S are formed along a front-rear direction between the upper edge of the locking lance 66 and the upper wall 64 and between the lower edge of the locking lance 66 and the lower wall 65. Thus, the locking lance 66 can be resiliently deformed inward and outward of the accommodation wall portion 62 with the base end on a rear end side connected to the side wall as a fulcrum. That is, the locking lance 66 is supported in a cantilever manner to extend toward the front side (toward the second opening 62b) opposite to a side where the wires 16 extend out from the accommodation wall portion 62 along an axial direction of the accommodation wall portion 62.

The locking protrusion 67 is a part projecting toward a holder accommodation space 62S, out of the locking lance 66. In this embodiment, the locking protrusion 67 partially projects in a width direction of the locking lance 66. More specifically, the locking protrusion 67 is formed in an upper part of the inner surface of the locking lance 66. The locking protrusion 67 is formed at a position to be fit into the locking recess 33 of the terminal module 30 with the terminal module 30 accommodated in the accommodation wall portion 62. The locking protrusion 67 has a guide surface 67f1 for gradually reducing a projecting dimension toward a rear side. In inserting the terminal module 30 into the accommodation wall portion 62, the terminal module 30 is pressed against the guide surface 67f1, whereby the locking protrusion 67 can be moved outward. The locking lance 66 returns to an initial shape and is fit into the locking recess 33 of the terminal module 30, whereby the terminal module 30 is restricted in position so as not to come out rearward.

The wire guiding portion 52 is a part integrally molded of resin together with the holder holding portion 60. The wire guiding portion 52 is formed into a rectangular tube shape. An upper end part of the wire guiding portion 52 is connected to a rear end side of the accommodation wall portion 62. Thus, upper, left and right sides of a rear space of the accommodation wall portion 62 are surrounded by an upper end part of the wire guiding portion 52.

The wire guiding portion 52 extends downward from a part connected to the rear end side of the accommodation wall portion 62. An internal space of the wire guiding portion 52 is formed to extend downward from behind the terminal module 30. The wires 16 extending out from the terminal module 30 are bent downward in an upper internal space of the wire guiding portion 52 behind the terminal module 30. The wires 16 are further led out downward through the inside of the wire guiding portion 52.

The wire guiding portion 52 guides the wires 16 in an overlapping direction of the base holder 34, the intermediate holder 36 and the cover holder 38, i.e. in the vertical direction.

A setting opening 52h is formed in a rear part of the wire guiding portion 52.

Since the setting opening 52h is open rearward of the accommodation wall portion 62, the terminal module 30 is easily set into the accommodation wall portion 62 through this setting opening 52h. Further, the setting opening 52h is open along a wire pull-out direction of the wires 16 from behind to below the accommodation wall portion 62. Thus, during a setting operation of the terminal module 30, the wires 16 extending out from the terminal module 30 can be pulled out from the housing 50 through the setting opening 52h. Thus, a routing space for the wires 16 is easily ensured during the setting operation of the terminal module 30.

The setting opening 52h is closed by a cover member 70. The cover member 70 is a component integrally molded of resin. The cover member 70 includes a plate-like cover body 71 for closing the setting opening 52h and locking pieces 72 extending out from the cover member 70. With the setting opening 52h closed by the cover body 71, locking protrusions 50p1 on the outer side surfaces of the housing 50 are locked into locking holes of the locking pieces 72. In this way, the cover member 70 is united with the housing 50 while closing the setting opening 52h.

An annular resilient member G2 for closing a gap between the inner peripheral edge of the setting opening 52h and the cover member 70 may be arranged between the inner peripheral edge of the setting opening 52h and the cover member 70.

Out of the wire guiding portion 52, a lower end part on a side opposite to the holder holding portion 60 is formed into an entirely surrounded pull-out end part 54. The wires 16 are pulled out to outside through the wire guiding portion 52 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

In this embodiment, an example in which the wire guiding portion 52 guides the wires 16 downward is described. The wire guiding portion 52 may guide the wires 16 in another direction. For example, the wire guiding portion 52 may guide the wires 16 straight rearward, rightward, leftward or upward. An example of a housing in which a wire guiding portion extends out from a holder holding portion in a horizontal direction, more specifically in a rightward direction, is described later.

### <Concerning Retainer>

As shown in FIGS. 2 to 5 and 7 to 10, the retainer 90 is a member for restricting the resilient deformation of the locking lances 66. More specifically, the retainer 90 restricts outward deformation of the locking lances 66. With the locking lances 66 locked to the terminal module 30, the locking lances 66 are restricted from being deformed outward by the retainer 90. In this way, the terminal module 30 is suppressed from coming out from the accommodation wall portion 62.

The retainer 90 is a component molded of resin or the like. In this embodiment, the retainer 90 is mounted in an end part on the side of the second opening 62b on the front side of the accommodation wall portion 62.

More specifically, the retainer 90 includes a front wall 91 and a peripheral wall 92.

The front wall 91 is in the form of a plate arrangeable to close the second opening 62b. Through holes, through which the mating terminals can pass, are formed at positions corresponding to the respective terminals 12 in the front wall 91.

The peripheral wall 92 is in the form of a rectangular tube surrounding the outer peripheral surface of a front end part of the accommodation wall portion 62. Mounting recesses 92g are formed in the inner surfaces of left and right wall parts of the peripheral wall 92 (see FIGS. 7 and 8). In this embodiment, mounting protrusions 62p are formed on the outward facing surfaces of the locking lances 66 (see FIG. 9). The mounting protrusions may be formed on the outer surface of the accommodation wall portion 62. If the retainer 90 is externally fit to the tip of the accommodation wall portion 62, the mounting protrusions 62p are fit into the mounting recesses 92g. In this way, the retainer 90 is mounted on the front end part of the accommodation wall portion 62 in a state where the peripheral wall 92 surrounds the outer peripheral surface of the front end part of the accommodation wall portion 62 and the front wall 91 is arranged in front of the accommodation wall portion 62.

The retainer 90 includes restricting portions 94 located outside the locking lances 66 to restrict outward movements of the locking lances 66. In this embodiment, parts, which are the inner surfaces of the left and right wall parts of the peripheral wall 92 and adjacent to the mounting recesses 92g, are the restricting portions 94. With the retainer 90 mounted on the front end part of the accommodation wall portion 62, the restricting portions 94 are arranged at positions facing the outward facing surfaces of the locking lances 66. Here, the restricting portions 94 are arranged at positions facing the outward facing surfaces of tip parts of the locking lances 66.

The restricting portion 94 and the locking lance 66 may be in contact. A gap may be formed between the restricting portion 94 and the locking lance 66 within a range that the locking of the locking protrusion 67 to the locking recess 33 cannot be released.

This gap is preferably set to be as small as possible.

### <Holding Structure for Terminal Module>

If the terminal module 30 is inserted into the accommodation wall portion 62 from behind, the front end edge of the terminal module 30 contacts the guide surfaces 67f1 of the locking protrusions 67 and displace the locking lances 66 outward. If the front end edge of the terminal module 30 moves beyond the locking protrusions 67, the locking lances 66 return to the original shape due to their resilient forces and the locking protrusions 67 are fit into the locking recesses 33. In this way, the terminal module 30 is prevented from coming out rearward.

Further, the protrusion 40 on the rear end of the terminal module 30 contacts the rear end part of the accommodation wall portion 62, whereby a forward movement of the terminal module 30 is restricted (see FIG. 10).

Thereafter, the retainer 90 is mounted on the front end part of the accommodation wall portion 62. Then, the restricting portions 94 face the outward facing surfaces of the locking lances 66. In this way, outward movements of the tip parts of the locking lances 66 are restricted and the locking protrusions 67 hardly move outward away from the locking recesses 33.

### <Reinforcement and Holding Structure of Terminal Module>

As described above, the wires 16 extend out from the rear end part 32R of the terminal holder 32. Further, the wires 16 are guided in a direction intersecting the extension direction of the cavities 34g1, 34g2, 36g1 and 36g2 by the wire guiding portion 52. Thus, if being pulled, the wire 16 is possibly strongly pressed against the rear opening edge of the cavity 34g1, 34g2, 36g1, 36g2. Thus, it is desired to reinforce the rear end part 32R of the terminal holder 32 and firmly hold the terminal holder 32 in the housing 50.

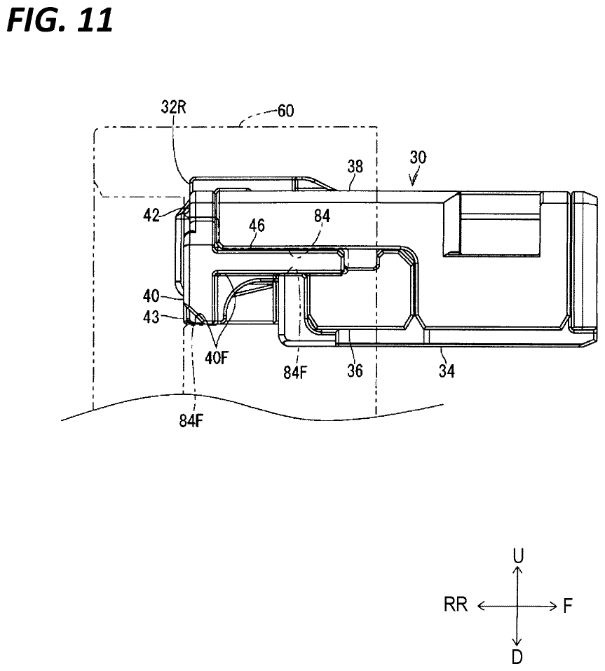

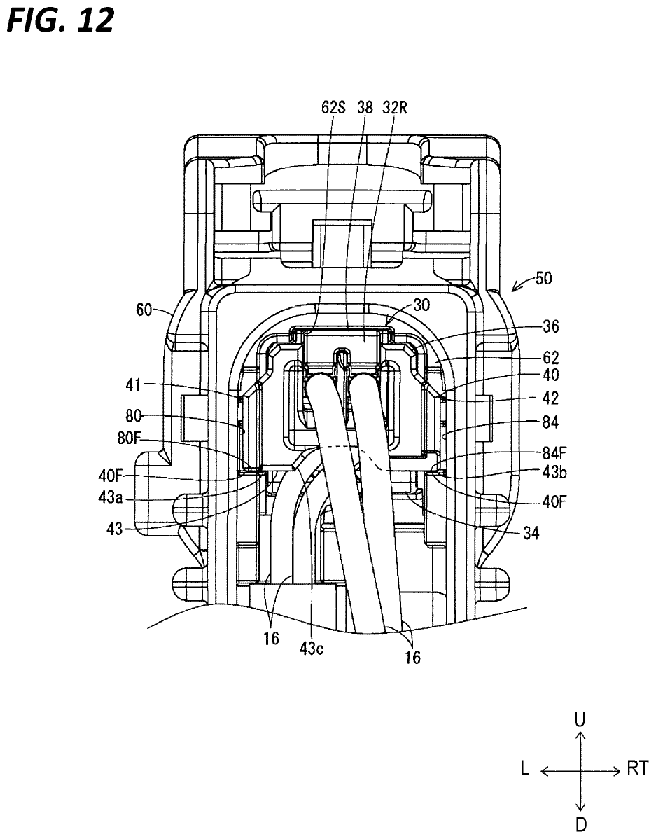

FIG. 11 is a diagram showing a state where the protrusion 40 of the terminal holder 32 is fit in the recess 84 of the housing 50. FIG. 12 is a back view showing the terminal module 30 held in the holder holding portion 60. As shown in FIGS. 6 to 8 and 10 to 12, in this embodiment, the terminal holder 32 includes the protrusion 40 projecting outward on an outer peripheral part of the rear end part 32R on a side of the terminal holder 32 where the wires 16 extend out. The rear end part 32R of the terminal holder 32 is a part located behind a center between the front and rear ends of the terminal holder 32. Preferably, the protrusion 40 is formed in a front region with the rear end surface of the terminal holder 32 as a starting point. An outer side is a side opposite to the inside of the terminal holder 32 and, for example, a side opposite to the cavities 34g1, 34g2, 36g1 and 36g2. The rear end part 32R of the terminal holder 32 is reinforced by the protrusion 40.

In this embodiment, an example in which the protrusion 40 is formed on the intermediate holder 36 is described. A protrusion may be formed on the base holder or the cover holder. It is not essential that the terminal holder has a divided structure and the terminal holder may be configured by a combination of a single holder housing and a retainer. In this case, a protrusion may be formed on the holder housing.

The holder holding portion 60 includes the recesses 80, 84, into which the protrusion 40 is at least partially fit. In this embodiment, the recesses 80, 84 are formed in parts extending more rearward than the outer wall portion 68, out of both inner side surfaces of the accommodation wall portion 62.

With the terminal holder 32 accommodated in the holder accommodation space 62S, the protrusion 40 is at least partially fit in the recesses 80, 84. In this way, the terminal holder 32 is firmly held in the housing 50.

More specifically, the protrusion 40 includes edge reinforcing portions 41, 42 and 43 along the edge of the rear end part 32R of the terminal holder 32.

The edge reinforcing portions 41, 42 are along left and right edges of the rear end part 32R of the terminal holder 32 (see FIGS. 6 to 8). More specifically, the edge reinforcing portion 41 is shaped to extend along the left edge of the rear end of the intermediate holder 36 and project leftward and outward. Further, the edge reinforcing portion 42 is shaped to extend along the right edge of the rear end of the intermediate holder 36 and project rightward and outward. An upper part of the edge reinforcing portion 41, 42 is shaped to gradually reduce a projecting length toward the upper side. The intermediate holder 36 projects more rearward than the cover holder 38, and the front surfaces of upper end parts of the edge reinforcing portions 41, 42 can contact the rear end of the cover holder 38. The edge reinforcing portions 41, 42 project further outward than both side surfaces of the base holder 34 and the cover holder 38.

The edge reinforcing portion 43 is along the lower edge of the rear end part 32R of the terminal holder 32. More specifically, the edge reinforcing portion 43 is shaped to extend along the lower edge of the rear end of the intermediate holder 36 and project downward and outward.

As described above, the rear end part of the intermediate holder 36 extends further rearward than the rear end part of the base holder 34, and the edge reinforcing portion 43 is located behind the base holder 34. The edge reinforcing portion 43 is located behind and away from the rear surface of the base holder 34. The wires 16 pulled out from a rear end part of the base holder 34 can be bent between the rear surface of the base holder 34 and the edge reinforcing portion 43. The edge reinforcing portion 43 may be located above the lower surface of the base holder 34 or may extend further downward than the lower surface of the base holder 34.

Both ends of the edge reinforcing portion 43 are connected to lower ends of the edge reinforcing portions 41, 42. The edge reinforcing portions 41, 42 can be said to extend upward from the both ends of the edge reinforcing portion 43.

The protrusion 40 includes rib portions 45, 46 extending along the extension direction of the cavities 34g1, 34g2, 36g1 and 36g2.

The rib portion 45 is a part projecting from the left side surface of the rear end part 32R of the terminal holder 32. More specifically, the rib portion 45 is a protrusion extending forward from the lower end of the edge reinforcing portion 41 and the left end of the edge reinforcing portion 43 on the left side surface of a rear end part of the intermediate holder 36. The rib portion 45 projects further outward than the left side surfaces of the base holder 34 and the cover holder 38.

The rib portion 45 includes an elongated protrusion 45a extending forward along the extension direction of the cavities 34g1, 34g2, 36g1 and 36g2 from an upper part of a front side thereof. A contact area of the protrusion 40 and the recess 80 can be increased by the protrusion 45a. Further, the rib portion 45 has a slope 45b extending obliquely rearward from a base end part on a lower side of the protrusion 45a. The rib portion 45 can be easily fit into the recess 80 from behind by the slope 45b.

The rib portion 46 is a part projecting from the right side surface of the rear end part 32R of the terminal holder 32. More specifically, the rib portion 46 is an elongated protrusion extending forward from a lower end part of the edge reinforcing portion 42 on the right side surface of the rear end part of the intermediate holder 36. The rib portion 46 projects further outward than the right side surfaces of the base holder 34 and the cover holder 38.

A vertical dimension of the rib portion 46 is smaller than that of the rib portion 45. More specifically, the lower end of the rib portion 46 is located above that of the rib portion 45. Thus, in a side view from right, a gap is formed between the rear end surface of the base holder 34 and the edge reinforcing portion 43.

As described later, the terminal holder 32 can also be applied to a housing 150 for pulling out the wires 16 rightward. In this case, the wires 16 are pulled out through this gap. The terminal holder 32 may be a component dedicated to the housing 50 for pulling out the wires 16 downward. In this case, the rib portion 46 may be shaped similarly to the rib portion 45.

The rib portions 45, 46 are examples of an intersecting protrusion projecting in a direction (lateral direction) intersecting an overlapping direction (vertical direction) of the base holder 34, the intermediate holder 36 and the cover holder 38.

In the extension direction of the cavities 34g1, 34g2, 36g1 and 36g2, the rib portions 45, 46 extend rearward from positions on the front side opposite to the rear end surface of the base holder 34 in the extension direction of the wires 16. That is, the front ends of the ribs 45, 46 are located in front of the rear end surface of the base holder 34 (see FIG. 11). Thus, a part extending rearward from the base holder 34, out of the intermediate holder 36, is reinforced by the rib portions 45, 46. Further, by fitting the ribs 45, 46 into the recesses 80, 84, the part extending rearward from the base holder 34, out of the intermediate holder 36, is firmly held via the rib portions 45, 46.

The recess 80 is formed in a part extending more rearward than the outer wall portion 68 in the left inner surface of the accommodation wall portion 62. The recess 80 is so shaped that the edge reinforcing portion 41, a left end part of the edge reinforcing portion 43 and the rib portion 45 are fittable thereinto. More specifically, the recess 80 is formed into a shape recessed in the left inner surface of the accommodation wall portion 62. The recess 80 is open toward the holder accommodation space 62S and rearward.

The spreading shape of the recess 80 in the left inner surface of the accommodation wall portion 62 is the same shape as a region where the edge reinforcing portion 41, the left end part of the edge reinforcing portion 43 and the rib portion 45 spread when the terminal holder 32 is viewed from left. Note that the spreading shape of the recess 80 may be larger than the region where the edge reinforcing portion 41, the left end part of the edge reinforcing portion 43 and the rib portion 45 spread in a range in which the protrusion 40 can contact the recess 80 to receive a pulling force when the wire 16 is pulled (e.g. may be larger by 10%, preferably by 5% in a dimension ratio).

The recess 84 is formed in a part extending more rearward than the outer wall portion 68 in the right inner surface of the accommodation wall portion 62. The recess 84 is so shaped that the edge reinforcing portion 42, a right end part of the edge reinforcing portion 43 and the rib portion 46 are fittable thereinto. More specifically, the recess 84 is formed into a shape recessed in the right inner surface of the accommodation wall portion 62. The recess 80 is open toward the holder accommodation space 62S and rearward.

The spreading shape of the recess 84 in the right inner surface of the accommodation wall portion 62 is the same shape as a region where the edge reinforcing portion 42, the right end part of the edge reinforcing portion 43 and the rib portion 46 spread when the terminal holder 32 is viewed from left. Note that, similarly to the recess 80, the spreading shape of the recess 80 may be larger than the region where the edge reinforcing portion 42, the right end part of the edge reinforcing portion 43 and the rib portion 46 spread in a range in which the protrusion 40 can contact the recess 80 to receive a pulling force when the wire 16 is pulled.

Surfaces of the protrusion 40 to be arranged in the recesses 80, 84 and facing in the guiding direction (downward direction) of the wires 16 by the wire guiding portion 52 are support target surfaces to be supported. In this embodiment, the lower surfaces of the left and right end parts of the edge reinforcing portion 43 and the lower surfaces of the rib portions 45, 46 are support target surfaces 40F.

Further, the lower surfaces of the recesses 80, 84 facing the support target surfaces 40F are support surfaces 80F, 84F.

If the terminal module 30 is inserted into the accommodation wall portion 62 from behind, the edge reinforcing portion 41, the left end part of the edge reinforcing portion 43 and the rib portion 45 are fit into the recess 80 from behind. Further, the edge reinforcing portion 42, the right end part of the edge reinforcing portion 43 and the rib portion 46 are fit into the recess 84 from behind.

Surfaces of the protrusion 40 facing forward contact rearward facing surfaces of the recesses 80, 84, whereby a forward movement of the terminal module 30 is restricted with the terminal module 30 accommodated in the holder accommodation space 62S.

Further, the support target surfaces 40F face the support surfaces 80F, 84F.

In this state, if the wire 16 is pulled downward, a lower part of a rear opening edge part of the cavity 36g1, 36g2 is pushed downward. Since the edge reinforcing portion 43 is formed along the lower edge of the rear end of the intermediate holder 36, the lower parts of the cavities 36g1, 36g2 are reinforced in strength.

Further, the lower surfaces of the left and right end parts of the edge reinforcing portion 43 are the support target surfaces 40F and facing the support surfaces 80F, 84F of the recesses 80, 84. If the wire 16 is pulled and the rear end part 32R of the terminal holder 32 moves downward, the support target surfaces 40F of the left and right end parts of the edge reinforcing portion 43 contact the support surfaces of the recesses 80, 84 and a downward movement of the terminal holder 32 is restricted.

Furthermore, the lower surfaces of the rib portions 45, 46 are also the support target surfaces 40F and facing the support surfaces 80F, 84F of the recesses 80, 84. Thus, a downward movement of the terminal holder 32 is restricted also by the contact of the support target surfaces 40F of the rib portions 45, 46 with the support surfaces 80F, 84F of the recesses 80, 84.

In this embodiment, the edge reinforcing portion 43 includes a first supporting end part 43a, a second supporting end part 43b and a coupling portion 43c (see FIGS. 7, 8 and 12). The coupling portion 43c couples the first and second supporting end parts 43a, 43b.

As described above, the first and second supporting end parts 43a, 43b, which are the left and right end parts of the edge reinforcing portion 43, are supported by the recess 80 when the wire 16 is pulled in the downward direction, which is the guiding direction of the wires 16.

The coupling portion 43c is separated from the housing 50. The coupling portion 43c has an arch shape concave toward a side (upper side) opposite to the downward direction, which is the guiding direction of the wires 16. If the lower part of the cavity 36g1, 36g2 is pushed downward, this force is supported by the first and second supporting end parts 43a, 43b via the coupling portion 43c having an arch structure. By forming the coupling portion 43c into the arch structure, a lower part of the rear end of the intermediate holder 36 can be firmly held. Further, by forming the coupling portion 43c into the arch structure, a material reduction and weight saving become possible. Further, since at least a partial region behind the cavities 36g1, 36g2 can be opened, a space for pulling out the wires 16 from the terminal holder 32 is easily ensured. For example, the wires 16 extending out from the terminal holder 32 can be guided by the wire guiding portion 52 while being caused to enter a recess of the coupling portion 43c.

Note that, although lower parts of rear opening edge parts of the cavities 34g1, 34g2 are also pressed downward, the lower edge of the rear end of the base holder 34 is located on the inner surface of the lower side of the accommodation wall portion 62. Thus, the lower edge of the rear end of the base holder 34 is firmly held by the inner surface of the accommodation wall portion 62 itself.

### <Effects, Etc.>

According to the connector 20 configured as described above, the terminal holder 32 includes the protrusion 40 projecting outward on the outer peripheral part of the rear end part 32R on the side where the wires 16 extend out. Thus, the strength of the rear end part 32R of the terminal holder 32 is improved. Further, since the protrusion 40 is fit into the recesses 80, 84, the rear end part 32R of the terminal holder 32 is firmly held in the housing 50. If the rear end part 32R of the terminal holder 32 is reinforced and firmly held, ease of handling during assembling and connecting operations of the connector 20 and the like is improved. An improvement in the ease of handling of the connector 20 can contribute to a cost reduction of the connector 20.

Further, the protrusion 40 has the support target surfaces 40F facing downward in the guiding direction of the wires 16, and the recesses 80, 84 have the support surfaces 80F, 84F facing the support target surfaces 40F. If the wire 16 is pulled in the guiding direction of the wires 16, the rear end part 32R of the terminal holder 32 is also pulled in the guiding direction. Then, the support target surfaces 40F contact the support surfaces 80F, 84F, thereby restricting a movement of the terminal holder 32 in the guiding direction. Thus, the rear end part 32R of the terminal holder 32 is firmly held in the housing 50.

Further, the protrusion 40 includes the edge reinforcing portions 41, 42 and 43 along the edge of the rear end part 32R of the terminal holder 32. Thus, the edge of the rear end part 32R is reinforced by the edge reinforcing portions 41, 42 and 43.

Further, the edge reinforcing portion 43 includes the arched coupling portion 43c. Thus, if the wire 16 is pulled, the coupling portion 43c between the first and second supporting end parts 43a, 43b can be firmly supported by the arch structure. In this way, even if a part between the first and second supporting end parts 43a, 43b, out of the rear end part 32R of the terminal holder 32, cannot be directly supported by the housing 50, this part can be firmly supported.

Further, the protrusion 40 includes the rib portions 45, 46 extending along the extension direction of the cavities 34g1, 34g2, 36g1 and 36g2. Thus, the terminal holder 32 is hardly deformed to be bent with respect to the extension direction of the terminals 12.

Since the intermediate holder 36 is arranged between the base holder 34 and the cover holder 38, it is difficult to bring the intermediate holder 36 into contact with the inner surface of the holder holding portion 60. Accordingly, the intermediate holder 36 is formed with the protrusion 40 and the protrusion 40 is fit into the recesses 80, 84, whereby the intermediate holder 36 is easily positioned.

Further, the rib portions 45, 46 as examples of the intersecting protrusion project in the direction (lateral direction) intersecting the overlapping direction (vertical direction) of the terminal holder 32 and are fit into the recesses 80, 84 to be able to contact the inner surfaces of the recesses 80, 84 in the guiding direction of the wires 16. Thus, the intermediate holder 36 arranged between the base holder 34 and the cover holder 38 can be effectively restricted in position in the guiding direction of the wires 16.

Further, if the intermediate holder 36 extend more outward than the base holder 34, it is difficult to support the rear end part of the intermediate holder 36 by the housing 50. Accordingly, by forming the intermediate holder 36 with the protrusion 40, the rear end part of the intermediate holder 36 is easily reinforced and firmly held at a fixed position.

Further, if the rib portions 45, 46 extend rearward from the side in front of the rear end surface of the base holder 34 in the extension direction of the cavities 34g1, 34g2, 36g1 and 36g2, a part extending from the base holder 34, out of the intermediate holder 36, can be firmly reinforced by the rib portions 45, 46. Further, if the rib portions 45, 46 are held in the recesses 80, 84, the part extending from the base holder 34, out of the intermediate holder 36, can be firmly held by the rib portions 45, 46.

### <Variation on Wire Guiding Direction>

The housing 50 is so shaped that the wire guiding portion 52 extends downward with respect to the holder holding portion 60. The terminal module 30 may be mounted into a housing for guiding the wires 16 in a direction different from the housing 50.

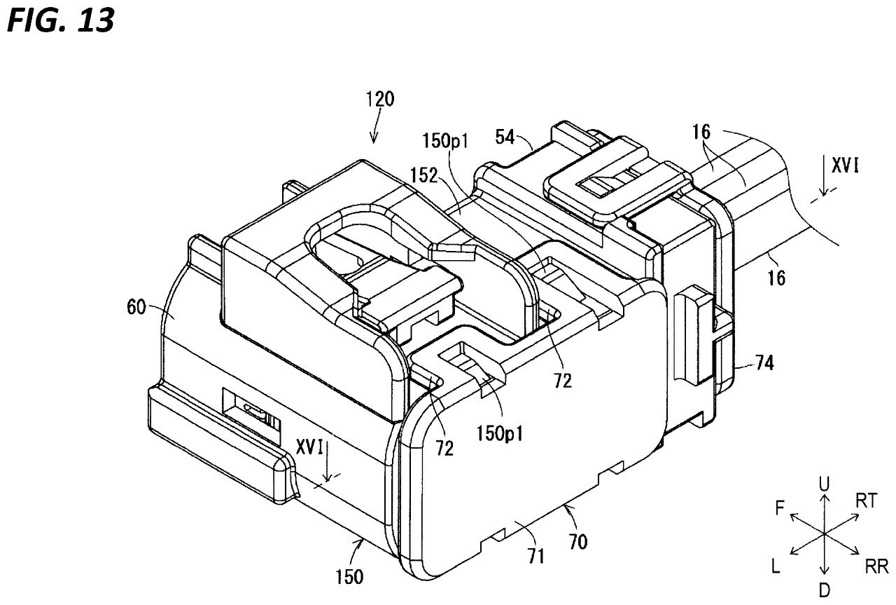

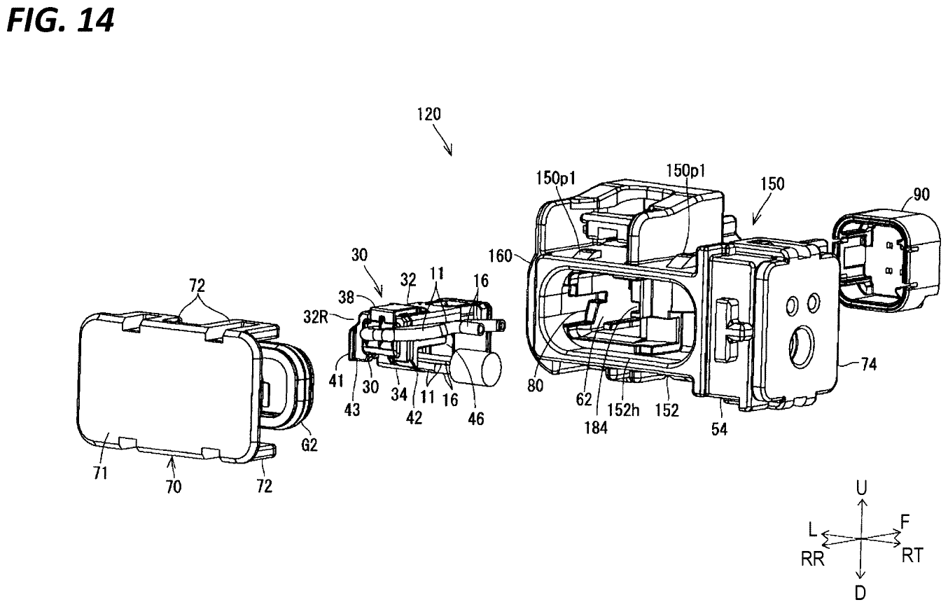

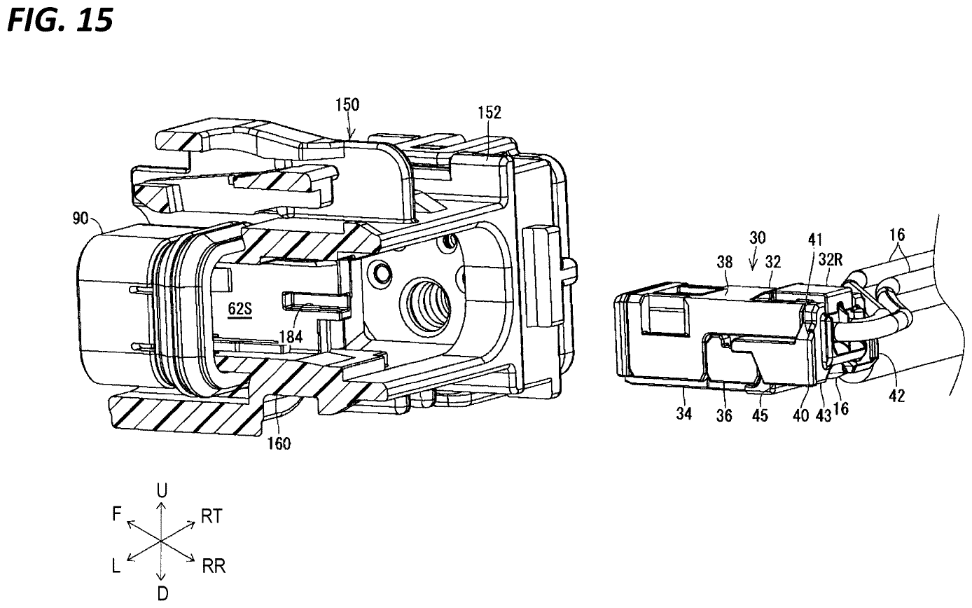

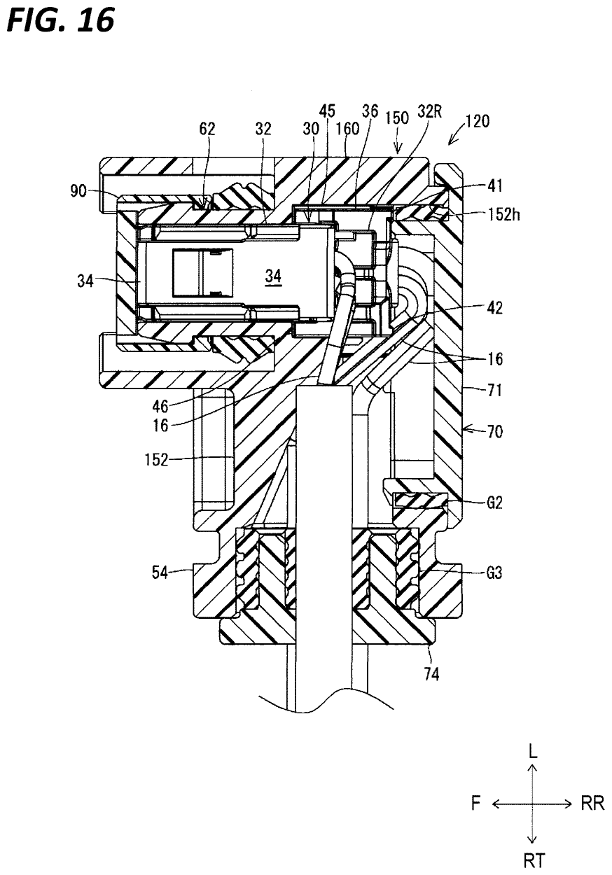

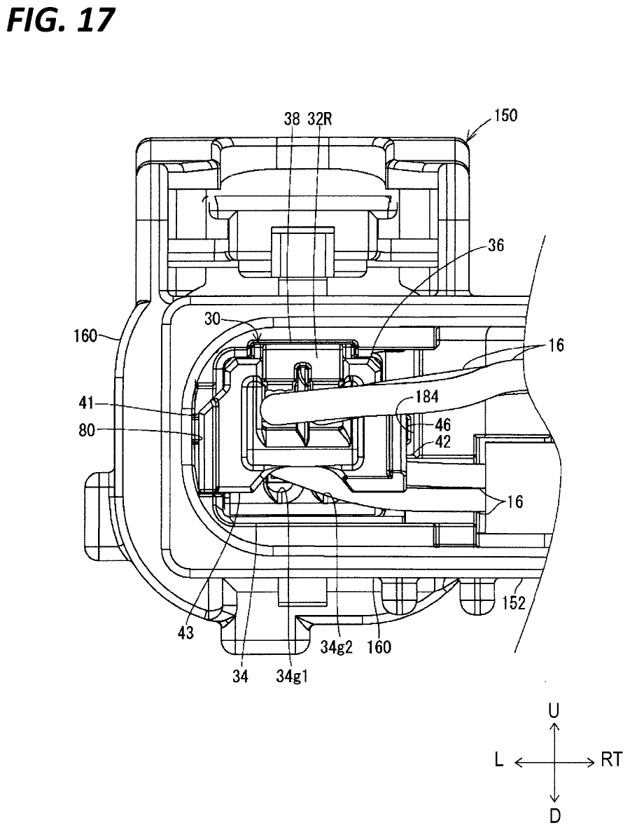

FIG. 13 is a perspective view showing a connector 120 different from the connector 20. FIG. 14 is an exploded perspective view showing the connector 120. FIG. 15 is a perspective view partly in section of the housing 150. FIG. 16 is a section along XVI-XVI of FIG. 13. FIG. 17 is a back view showing a terminal module 30 held in a holder holding portion 160.

This connector 120 is configured to guide wires 16 in a lateral direction with respect to the terminal module 30.

This connector 120 is described, centering on points of difference from the connector 20.

The connector 120 is provided with terminal-equipped wires 11, a terminal holder 32 and the housing 150.

The terminal-equipped wires 11 and the terminal holder 32 are the same as the terminal-equipped wires 11 and the terminal holder 32 described with respect to the connector 20. Thus, the terminal module 30 is used as a component common to the connectors 20 and 120.

A retainer 90 may also be the same as the retainer 90 described with respect to the connector 20.

The housing 150 is provided with the holder holding portion 160 and a wire guiding portion 152. The holder holding portion 160 may be a part having the same shape as the holder holding portion 60 described with respect to the connector 20 except a configuration on recesses, into which a protrusion 40 is fit.

The wire guiding portion 152 is a part integrally molded of resin together with the holder holding portion 160 and in the form of a rectangular tube, similarly to the wire guiding portion 52.

Unlike the wire guiding portion 52, the wire guiding portion 152 extends in a horizontal direction and one end part (left end part) thereof is connected to a rear end side of an accommodation wall portion 62. Thus, the wire guiding portion 152 extends in the horizontal direction from a part connected to the rear end side of the accommodation wall portion 62. An internal space of the wire guiding portion 152 is formed to extend rightward along the horizontal direction from behind the terminal module 30. The wires 16 extending out from the terminal module 30 are bent rightward in the internal space of one end part (left end part) of the wire guiding portion 152 behind the terminal module 30. The wires 16 are further led out rightward to outside through the inside of the wire guiding portion 152.

Thus, the wire guiding portion 152 guides the wires 16 along a direction intersecting both an extension direction (front-rear direction) of cavities 34g1, 34g2, 36g1 and 36g2 and an overlapping direction (vertical direction) of a base holder 34, an intermediate holder 36 and a cover holder 38.

That is, the housings 50, 150 guide the wires 16 extending out from the terminal module 30 in the directions intersecting the extension direction of the terminals 12, but guiding directions are different. The housing 50 guides the wires 16 toward the base holder 34 along a stacking direction of the intermediate holder 36 on the base holder 34. The housing 150 guides the wires 16 in an arrangement direction of first cavities 34g1, 36g1 and second cavities 34g2, 36g2 (see FIG. 6).

A setting opening 152h is formed in a rear part of the wire guiding portion 152, similarly to the wire guiding portion 52.

Since the setting opening 152h is open in a rear part of the accommodation wall portion 62, the terminal module 30 is easily set into the accommodation wall portion 62 through this setting opening 152h. Further, the setting opening 152h is open along a pull-out direction of the wires 16 along the horizontal direction from behind the accommodation wall portion 62. Thus, during a setting operation of the terminal module 30, the wires 16 extending out from the terminal module 30 can be pulled out from the housing 150 through the setting opening 152h. Thus, a routing space for the wires 16 is easily ensured during the setting operation of the terminal module 30.

The setting opening 152h is closed by a cover member 70. This cover member 70 may be the same as the cover member 70 described with respect to the connector 20. With the setting opening 152h closed by a cover body 71, locking protrusions 150p1 on the outer side surfaces of the housing 150 are locked into locking holes of locking pieces 72. In this way, the cover member 70 is united with the housing 150 while closing the setting opening 152h.

An annular resilient member G2 for closing a gap between the inner peripheral edge of the setting opening 152h and the cover member 70 may be arranged between the inner peripheral edge of the setting opening 152h and the cover member 70.

Out of the wire guiding portion 152, a lower end part on a side opposite to the holder holding portion 160 is formed into an entirely surrounded pull-out end part 54, similarly to the wire guiding portion 52. The wires 16 are pulled out to outside through the wire guiding portion 152 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

A recess 80 similar to the one described above is formed in the left inner surface of the holder holding portion 160. A recess 184 is formed in the left inner surface of the holder holding portion 160. The recess 184 is so shaped that a rib portion 46 is fittable thereinto, i.e. formed into a groove shape elongated in the front-rear direction.

With the terminal holder 32 held in the holder holding portion 160, an edge reinforcing portion 41 on a left side, the left end of an edge reinforcing portion 43 and a rib portion 45 are fit in the recess 80 as in the connector 20. Further, an edge reinforcing portion 42 on a right side and the right end of the edge reinforcing portion 43 are not fit into the recess 184, but the rib portion 46 is fit into the recess 184.

In this connector 120, if the wire 16 is pulled, a right part of an exit-side opening edge of the cavity 36g2 on the right side is pushed rightward. Since the edge reinforcing portion 42 is located on the right edge of the rear end of the intermediate holder 36, the right side of the exit-side opening edge of the cavity 36g2 on the right side is reinforced.

Further, the rib portion 46 extends from the edge reinforcing portion 42 and is fit into the recess 184. In this connector 120, the rib portion 46 is an example of a guiding direction-side protrusion projecting in the guiding direction of the wires 16 (rightward). Atop part of the rib portion 46 is facing the inner surface of the recess 184. If the wire 16 is strongly pulled and the rear end part 32R of the terminal holder 32 moves rightward, the top part of the rib portion 46 contacts the inner surface of the recess 184 to restrict a rightward movement. Thus, the rear end of the terminal holder 32 is firmly held and a rightward movement is suppressed. Thus, the intermediate holder 36 can be effectively restricted in position in the guiding direction of the wires 16.

Note that the respective configurations described in the above embodiment and each modification can be approximately combined without contradicting each other.

### LIST OF REFERENCE NUMERALS

11 terminal-equipped wire
12 terminal
12a wire connecting portion
12b terminal connecting portion
12g recess
16 wire
20, 120 connector
30 terminal module
32 terminal holder
32R rear end part
33 locking recess
34 base holder
34FW front wall
34SW, 36SW side wall
34W, 36W partition wall
34g1, 36g1, 34g2, 36g2 cavity
34gp, 36gp positioning protrusion
34r1, 34r2 locking protrusion 36 intermediate holder 36p, 38p locking piece
38 cover holder
40 protrusion
40F support target surface
41, 42, 43 edge reinforcing portion
43a first supporting end part
43b second supporting end part
43c coupling portion
45 rib portion (intersecting protrusion)
46 rib portion (intersecting protrusion, guiding direction-side protrusion)
45a protrusion
45b slope
50, 150 housing
50p1, 150p1 locking protrusion
52, 152 wire guiding portion
52h, 152h setting opening
54 pull-out end part
60, 160 holder holding portion
61 coupling wall
62 accommodation wall portion
62S holder accommodation space
62a first opening
62b second opening
62p mounting protrusion
63 side wall
64 upper wall
65 lower wall
66 locking lance
67 locking protrusion
67f1 guide surface
68 outer wall portion
68a lock piece
70 cover member
71 cover body
72 locking piece
74 pressing member
80, 84, 184 recess
80F, 84F support surface
90 retainer
91 front wall
92 peripheral wall
92g mounting recess
94 restricting portion
G1, G2 annular resilient member
G3 rubber plug
S slit

1. A connector for holding a terminal via a terminal holder, comprising:
a terminal-equipped wire including a wire and the terminal mounted on an end part of the wire;
the terminal holder including a cavity for holding the terminal; and
a housing including a holder holding portion for holding the terminal holder and a wire guiding portion for guiding the wire extending out from the holder holding portion,
the terminal holder including a protrusion projecting outward on an outer peripheral part of a rear end part of the terminal holder where the wire extends out, and
the holder holding portion including a holder accommodation space for accommodating the terminal holder and a recess, the protrusion being at least partially fit into the recess.

2. The connector of claim 1, wherein:
the protrusion has a support target surface facing in a guiding direction of the wire by the wire guiding portion, and
the recess has a support surface facing the support target surface.

3. The connector of claim 1, wherein the protrusion includes an edge reinforcing portion along an edge of the rear end part of the terminal holder.

4. The connector of claim 3, wherein:
the edge reinforcing portion includes a first supporting end part, a second supporting end part and a coupling portion coupling the first and second supporting end parts,
the first and second supporting end parts are supported in the recess when the wire is pulled in the guiding direction of the wire by the wire guiding portion, and
the coupling portion includes an arched part concave toward a side opposite to the guiding direction of the wire.

5. The connector of claim 1, wherein the protrusion includes a rib portion extending along an extension direction of the cavity.

6. The connector of claim 1, wherein:
the terminal holder includes a base holder, an intermediate holder to be overlapped on the base holder and a cover holder to be overlapped on the intermediate holder on a side opposite to the base holder,
each of the base holder and the intermediate holder is formed with the cavity, and
the intermediate holder is formed with the protrusion.

7. The connector of claim 6, wherein:
the wire guiding portion guides the wires along an overlapping direction of the base holder, the intermediate holder and the cover holder,
the protrusion includes an intersecting protrusion projecting in a direction intersecting the overlapping direction, and
the intersecting protrusion is fit into the recess to be able to contact an inner surface of the recess in a guiding direction of the wire.

8. The connector of claim 6, wherein:
the wire guiding portion guides the wires along a direction intersecting both an extension direction of the cavities and an overlapping direction of the base holder, the intermediate holder and the cover holder,
the protrusion includes a guiding direction-side protrusion projecting in the guiding direction of the wires, and
a top part of the guiding direction-side protrusion is fit into the recess to be able to contact an inner surface of the recess.

9. The connector of claim 6, wherein:
the intermediate holder extends more outward than the base holder in an extension direction of the cavities.

10. The connector of claim 9, wherein:
the protrusion includes a rib portion extending along the extension direction of the cavities, and
the rib portion extends in the extension direction of the cavities toward the rear end part from a position opposite to a rear end surface of the base holder in an extension direction of the wires.
